(19) United States
(12) Patent Application Publication
(10) Pub. No.: US 2014/0032029 A1
(43) Pub. Date: Jan. 30, 2014

(54) ELECTRICALLY POWERED VEHICLE AND CONTROL METHOD THEREFOR

(71) Applicants: Takahiko Hirasawa, Toyota-shi (JP); Keiji Kaita, Miyoshi-shi (JP)

(72) Inventors: Takahiko Hirasawa, Toyota-shi (JP); Keiji Kaita, Miyoshi-shi (JP)

(73) Assignee: TOYOTA JIDOSHA KABUSHIKI KAISHA, Toyota-shi, Aichi-ken (JP)

(21) Appl. No.: 14/112,485

(22) PCT Filed: Apr. 18, 2011
(86) PCT No.: PCT/JP2011/059522

§ 371 Date: Oct. 17, 2013

(51) Int. Cl. B60L 11/18

(52) U.S. Cl. CPC B60L 11/18
USPC 701/22; 701/1

(57) ABSTRACT

An electrically powered vehicle includes an electric motor for generating a vehicle driving force in accordance with an accelerator operation amount by a driver, and a notification unit for notifying the driver of information about accelerator operation by the driver in a mode which makes the driver sense the accelerator operation amount more easily in the case where a wheel is in contact with an obstacle than in the case where the wheel is not in contact with the obstacle.

### TECHNICAL FIELD

The present invention relates to an electrically powered vehicle and a control method therefor, and more particularly, relates to an electrically powered vehicle mounted with an electric motor for generating a driving force in accordance with a stepped amount of an accelerator pedal by a driver and a control method therefor.

### BACKGROUND ART

Generally, in a vehicle, a driving force required by the entire vehicle is calculated on the basis of driving operations such as a stepped amount of an accelerator pedal by a driver and a state of the vehicle, and a power source is controlled to achieve the calculated driving force. For example, in a normal vehicle with only an engine served as the power source, a driving state of the engine is configured to match a running state of the vehicle desired by the driver by making an engine throttle and the stepped amount of the accelerator pedal in conjunction with each other.

When such vehicle is in a state (hereinafter referred to as “locked state”) in which a wheel is in contact with an obstacle such as a step or a wheel block, in order to make the wheel climb over the obstacle so as to free it from the locked state, the driver is required to perform fine accelerator operations. For example, in order to climb over a step, it is necessary to generate a greater driving force by further stepping down the accelerator pedal. However, after the vehicle climbs over the step, a running resistance will decrease rapidly, which makes the driver have such a feeling that the vehicle is rushing out.

In order to solve such problem, for example, Japanese Patent Laying-Open No. 9-48263 (PTD 1) discloses a vehicle configured to make a fine movement automatically by controlling both a throttle actuator and a brake pedal when a desired running distance is input by the driver. In PTD 1, a controller keeps increasing a throttle opening degree until a detection value of an actual running distance by the vehicle becomes a positive value, i.e., until the vehicle starts running. On the other hand, as the throttle opening degree reaches an upper limit, the controller instructs a throttle actuator to fully close the throttle, and meanwhile instructs a brake actuator to stop the vehicle immediately. Furthermore, the controller causes an alarm to output an alarm sound. Thereby, according to PTD 1, in the case where there is an increasing running resistance such as a step or the like, the vehicle is prevented from sudden acceleration after climbing over a step by automatically stopping the vehicle as soon as the accelerator opening degree reaches the upper limit.

### CITATION LIST

### Patent Document

PTD 1: Japanese Patent Laying-Open No. 9-48263
PTD 2: Japanese Patent Laying-Open No. 7-315078
PTD 3: Japanese Patent Laying-Open No. 2007-125921
PTD 4: Japanese Patent Laying-Open No. 2009-271809
PTD 5: Japanese Patent Laying-Open No. 2010-221788
PTD 6: Japanese Patent Laying-Open No. 2010-241243

### SUMMARY OF INVENTION

### Technical Problem

In the case of a normal vehicle which runs with only an engine served as the power source disclosed in PTD 1, the vehicle is moved for a very short distance automatically without needing the driver to perform accelerator operations. Thus, such situation where a driver actually performs accelerator operations at a step or the like is not taken into consideration by PTD 1.

Here, it is assumed that a driver actually operates the accelerator pedal in climbing over a step. In a normal vehicle with only an engine served as a power source, when the driver steps down the accelerator pedal, a driving sound of the engine varies in accordance with the stepped amount. Therefore, through the driving sound of the engine which increases in accordance with the increasing stepped amount of the accelerator pedal, it is possible to make the driver recognize the state where a wheel is in the locked state and the operation amount of the accelerator pedal. As a result, it is possible to prevent the driver from stepping down the accelerator pedal excessively so as to suppress the feeling that the vehicle is rushing out after climbing over the step.

On the contrary, in an electrically powered vehicle with an electric motor served as a power source (for example, an electric vehicle, a hybrid vehicle, a fuel cell vehicle and the like), since the driving sound of the electric motor is relatively small in comparison with the driving sound of the engine, it is difficult to make the driver recognize the state where a wheel is in the locked state and the operation amount of the accelerator pedal through the driving sound of the electric motor. Thus, it is possible that the driver may misjudge the state where a wheel is in the locked state as a state where a sufficient torque is not output from the electric motor due to an insufficient stepped amount of the accelerator pedal, which thereby makes the driver to further step down the accelerator pedal.

Accordingly, the present invention has been accomplished in view of the aforementioned problems, and it is therefore an object of the present invention to provide an electrically powered vehicle capable of suppressing the feeling that the vehicle is rushing out when a wheel is in a locked state, and a control method therefor.

### Solution to Problem

According to an aspect of the present invention, an electrically powered vehicle includes an electric motor for generating a vehicle driving force in accordance with an accelerator operation amount by a driver, and a notification unit for notifying the driver of information about accelerator operation by the driver in a mode which makes the driver sense the accelerator operation amount more easily in the case where a wheel is in contact with an obstacle than in the case where the wheel is not in contact with the obstacle.

Preferably, the notification unit, in the case where the wheel is in contact with the obstacle, notifies the driver of the information about accelerator operation by the driver when the accelerator operation amount is equal to or greater than a prescribed reference amount.

Preferably, the electrically powered vehicle further includes an estimation unit for estimating a gradient of a road. The notification unit determines that the wheel is in contact with the obstacle when a first condition that the estimated gradient of the road is smaller than a prescribed threshold, a second condition that the accelerator operation amount is equal to or greater than a prescribed amount, and a third condition that a vehicular speed is smaller than a prescribed speed are satisfied.

Preferably, the notification unit includes a display unit for displaying at least a parameter about a vehicle driving force generated by the electric motor. The display unit displays the detected accelerator operation amount when the detected accelerator operation amount is equal to or greater than the prescribed reference amount.

Preferably, the notification unit includes a light source configured to be capable of blinking. The light source alters a blinking cycle in accordance with the detected accelerator operation amount when the accelerator operation amount is equal to or greater than the prescribed reference amount.

Preferably, the notification unit includes a sound output unit configured to be capable of generating a sound.

According to another aspect of the present invention, a control method for an electrical vehicle including an electric motor capable of generating a vehicle driving force in accordance with an accelerator operation amount by a driver and a notification unit for notifying the driver of information includes the steps of: detecting a state in which a wheel is in contact with an obstacle; detecting the accelerator operation amount by the driver; and controlling the notification unit to notify the driver of information about accelerator operation by the driver in a mode which makes the driver sense the accelerator operation amount more easily in the case where the state in which the wheel is in contact with the obstacle is detected than in the case where the wheel is not in contact with the obstacle.

### Advantageous Effects of Invention

According to the present invention, in the case where a wheel of an electrically powered vehicle is in a locked state, it is possible to suppress a feeling that the vehicle is rushing out when the wheel is freed from the locked state.

### BRIEF DESCRIPTION OF DRAWINGS

FIG. 1 is a schematic view illustrating a configuration of a hybrid vehicle serving as a representative example of an electrically powered vehicle according to an embodiment of the present invention;

FIG. 2 is a schematic view for explaining in detail a power train in the hybrid vehicle of FIG. 1;

FIG. 3 is a block diagram illustrating a control structure in an ECU according to the present embodiment;

FIG. 4 is a block diagram explaining controls of a combination meter according to an embodiment of the present invention;

FIG. 5 is a flowchart for achieving the controls of the combination meter according to an embodiment of the present invention;

FIG. 6 is a view illustrating an example of a power meter according to an embodiment of the present invention;

FIG. 7 is a conceptual diagram illustrating operations of a telltale according to an embodiment of the present invention; and

FIG. 8 is a flowchart for achieving controls of a combination meter according to a modification of an embodiment of the present invention.

### DESCRIPTION OF EMBODIMENTS

Hereinafter, embodiments of the present invention will be described in detail with reference to the drawings. It should be noted that the same or corresponding portions in the drawing will be given the same reference symbols and the description thereof will not be repeated.

(Configuration of Electrically Powered Vehicle)

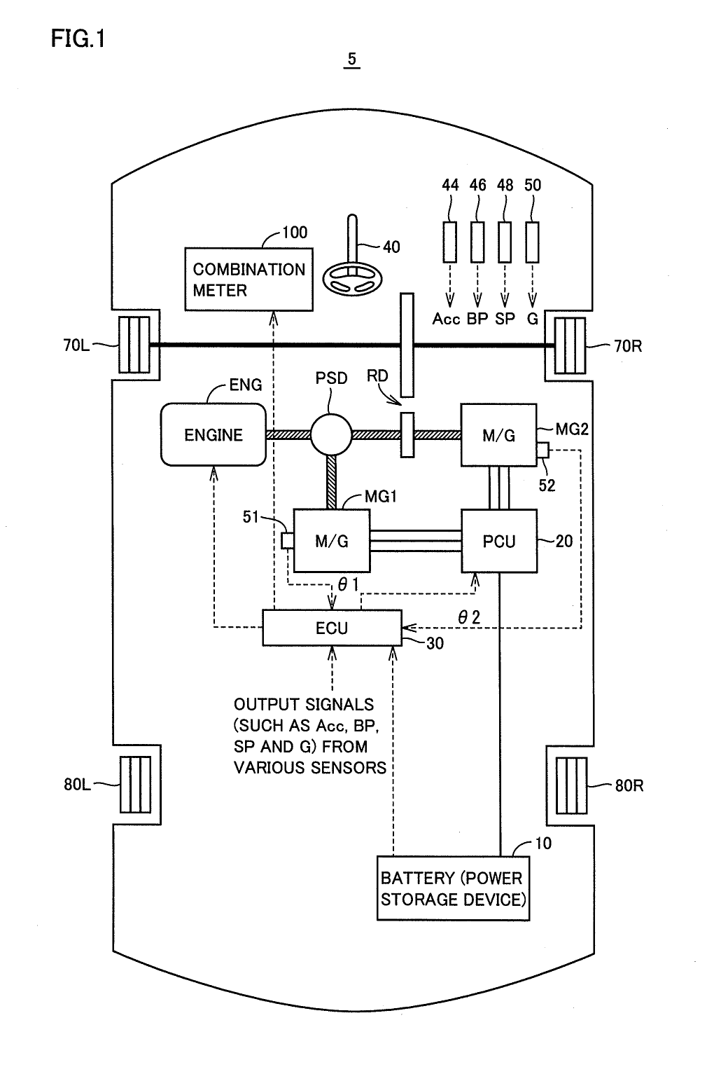

FIG. 1 is a schematic view illustrating a configuration of a hybrid vehicle 5 serving as a representative example of an electrically powered vehicle according to an embodiment of the present invention.

With reference to FIG. 1, hybrid vehicle 5 includes an engine ENG, motor generators MG1 and MG2, a battery 10, a power conversion unit (PCU) 20, a power split device PSD, a reduction device RD, front wheels 70L and 70R, rear wheels 80L and 80R, and an electronic control unit (ECU) 30. A control device according to the present embodiment is embodied through execution of a program by ECU 30, for example. In FIG. 1, hybrid vehicle 5 is exemplified to have front wheels 70L and 70R served as drive wheels; however, it is acceptable that rear wheels 80L and 80R serve as the drive wheels in place of front wheels 70L and 70R. Alternatively, in addition to the configuration in FIG. 1, a motor generator for driving rear wheels 80L and 80R may be further disposed so as to achieve a 4WD configuration.

The driving force generated by engine ENG is split into two paths by power split device PSD. One path is for driving front wheels 70L and 70R via reduction device RD. The other path is for driving the motor generator MG1 to generate electric power.

Motor generator MG1 is typically constituted by a three-phase AC synchronous motor generator. Driven by the driving force of engine ENG split by power split device PSD, motor generator MG1 generates electric power as a generator. Not only motor generator MG1 functions as a generator but also functions as an actuator for controlling the rotation speed of engine ENG.

The electric power generated by motor generator MG 1 is selectively distributed in accordance with an operating state of the vehicle and a SOC (State Of Charge) of battery 10. For example, in normal running and rapid acceleration, the electric power generated by motor generator MG1 is used directly as the power to drive motor generator MG2 as a motor. On the other hand, in the case where the SOC of battery 10 is less than a prescribed value, the electric power generated by motor generator MG1 is converted by power conversion unit 20 from AC power to DC power and stored in battery 10.

Motor generator MG1 is also used as a starter in starting engine ENG. When starting engine ENG, motor generator MG1 is supplied with electric power from battery 10 and works as an electric motor. Thus, motor generator MG1 cranks engine ENG to start it.

Motor generator MG2 is typically constituted by a three-phase AC synchronous motor generator. When motor generator MG2 is driven as an electric motor, it is driven by at least one of the electric power stored in battery 10 and the electric power generated by motor generator MG1. A driving force of motor generator MG2 is transmitted to front wheels 70L and 70R through the intermediary of reduction device RD. Thereby, the vehicle is driven to run by engine ENG assisted by motor generator MG2 or to run by only the driving force from motor generator MG2.

In a regenerative braking of the vehicle, motor generator MG2 is driven by front wheels 70L and 70R through the intermediary of reduction device RD, and motor generator MG2 is made to work as a generator. Thereby, motor generator MG2 works as a regenerative brake which converts braking energy into electric energy. The electric power generated by motor generator MG2 is stored in battery 10 through the intermediary of power conversion unit 20.

Battery 10 is constituted by, for example, a secondary battery such as a nickel-metal hydride battery or a lithium-ion battery. In the embodiments of the present invention, battery 10 is illustrated as a representative example of a “power storage device”. In other words, any other power storage device such as an electric double-layer capacitor may also be used in place of battery 10. Battery 10 supplies a DC voltage to power conversion unit 20, and meanwhile is charged with a DC voltage from power conversion unit 20.

Power conversion unit 20 performs a bidirectional electric power conversion from DC power supplied by battery 10 into AC power for driving and controlling the motor and from AC power generated by the generators into DC power.

Hybrid vehicle 5 further includes a steering wheel 40, an accelerator position sensor 44 for detecting an accelerator opening degree Acc corresponding to a stepped amount of the accelerator pedal by the driver, a brake pedal position sensor 46 for detecting a brake pedal position BP, a shift position sensor 48 for detecting a shift position SP, and a G sensor 50 for detecting an acceleration of hybrid vehicle 5.

Further, motor generators MG1 and MG2 are disposed with rotation angle sensors 51 and 52 for detecting a rotor rotation angle, respectively. A rotor rotation angle θ1 of motor generator MG1 detected by rotation angle sensor 51 and a rotor rotation angle θ2 of motor generator MG2 detected by rotation angle sensor 52 are transmitted to ECU 30. It should be noted that rotation angle sensor 51 and 52 may be omitted in case that rotor rotation angle θ1 can be estimated in ECU 30 on the basis of a current, a voltage or the like of motor generator MG1 and rotor rotation angle θ2 can be estimated in ECU 30 on the basis of a current, a voltage or the like of motor generator MG2.

ECU 30 is electrically connected to engine ENG, power conversion unit 20 and battery 10. On the basis of detection signals from various sensors, ECU 30 collectively controls the operating state of engine ENG, the driving state of motor generators MG1 and MG2, and the state of charge of battery 10 so as to keep hybrid vehicle 5 in a desired running state.

ECU 30 is further electrically connected to a combination meter 100 disposed in the front of the driver's seat in hybrid vehicle 5. As to be described later, combination meter 100 includes a display panel configured to be capable of displaying various information (text information and image information) for the driver to perform the driving, and a speaker capable of outputting audio sound to the driver. Under the control of ECU 30, the display panel and the speaker can notify the driver of various information. In other words, combination meter 100 constitutes a “notification unit” according to the present invention.

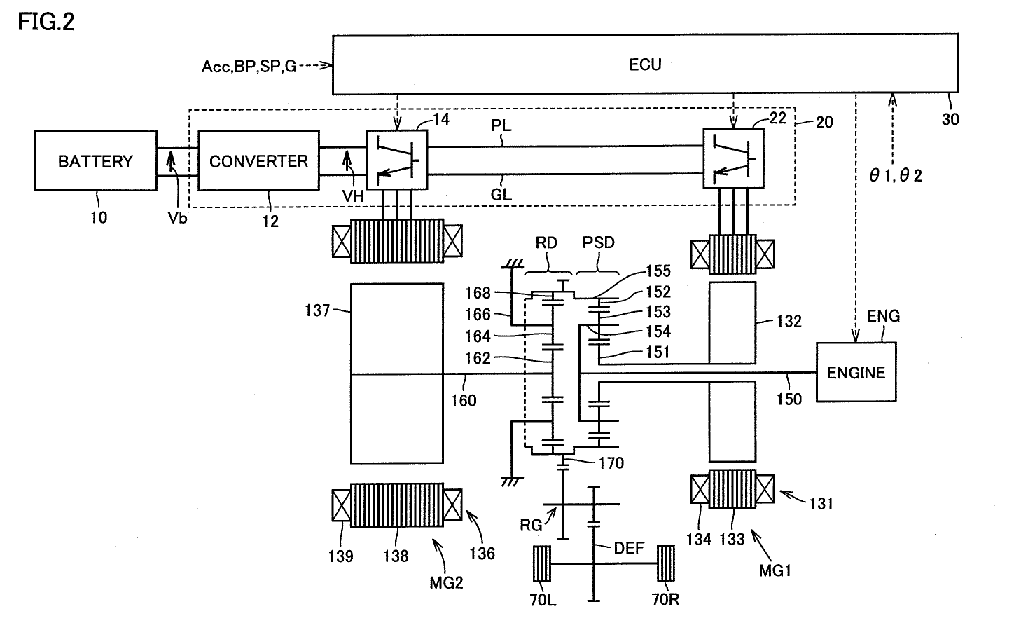

FIG. 2 is a schematic diagram for explaining in detail a power train in hybrid vehicle 5 of FIG. 1.

With reference to FIG. 2, the power train (hybrid system) of hybrid vehicle 5 includes motor generator MG2, reduction device RD coupled to an output shaft 160 of motor generator MG2, engine ENG, motor generator MG1, and power split device PSD.

In the example illustrated in FIG. 2, power split device PSD is constituted by a planetary gear mechanism, and includes a sun gear 151 coupled to a sun gear shaft which is hollow and has a shaft center thereof through which a crank shaft 150 is penetrated, a ring gear 152 which is supported in such a way that it can rotate coaxially with crank shaft 150, a pinion gear 153 which is disposed between sun gear 151 and ring gear 152 and is configured to revolve while rotating along the outer periphery of sun gear 151, and a planetary carrier 154 which is coupled to an end portion of crank shaft 150 for supporting the rotation shaft of each pinion gear 153.

Power split device PSD has three shafts including the sun gear shaft coupled to sun gear 151, a ring gear case 155 coupled to ring gear 152 and crank shaft 150 coupled to planetary carrier 154, and the three shafts serve as power input/output shafts. As the power input or output to any two shafts among the three shafts is determined, the power input to the remaining shaft is determined on the basis of the power input or output to the two other shafts.

A counter drive gear 170 for retrieving power is disposed outside ring gear case 155 and is configured to rotate integrally with ring gear 152. Counter drive gear 170 is coupled to a power transmission reduction gear RG. Ring gear case 155 corresponds to an “output member” in the present invention. Accordingly, in accordance with the electric power and the power input/output from the motor generator MG1, power split device PSD outputs at least a part of the output from engine ENG to the output member.

Moreover, the transmission of power is performed between counter drive gear 170 and power transmission reduction gear RG. Power transmission reduction gear RG drives a differential gear DEF which is connected to front wheels 70L and 70R serving as drive wheels. On a descending slope or the like, the rotation of the drive wheels is transmitted to differential gear DEF, and power transmission reduction gear RG is driven by differential gear DEF.

Motor generator MG1 includes a stator 131 which generates a rotating magnetic field, and a rotor 132 which is disposed inside stator 131 and has a plurality of permanent magnets embedded therein. Stator 131 includes a stator core 133 and a three-phase coil 134 wound around stator core 133. Rotor 132 is coupled to the sun gear shaft rotating integrally with sun gear 151 of power split device PSD. Stator core 133 is formed through stacking thin electromagnetic steel sheets, and is fixed to a case (not shown).

Motor generator MG1 operates as an electric motor which rotates rotor 132 according to the interaction between a magnetic field generated by the permanent magnets embedded in rotor 132 and a magnetic field generated by three-phase coil 134. Motor generator MG1 also operates as a generator which generates an electromotive force at both ends of three-phase coil 134 according to the interaction between the magnetic field generated by the permanent magnets and the rotation of rotor 132.

Motor generator MG2 includes a stator 136 which generates a rotating magnetic field, and a rotor 137 which is disposed inside stator 136 and has a plurality of permanent magnets embedded therein. Stator 136 includes a stator core 138 and a three-phase coil 139 wound around stator core 138.

Rotor 137 is coupled to ring gear case 155 rotating integrally with ring gear 152 of power split device PSD through the intermediary of reduction device RD. Stator core 138 is formed through stacking, for example, thin electromagnetic steel sheets, and is fixed to a case (not shown).

Similarly, motor generator MG2 operates as a generator which generates an electromotive force at both ends of three-phase coil 139 according to the interaction between the magnetic field generated by the permanent magnets and the rotation of rotor 137. Motor generator MG2 also operates as an electric motor which rotates rotor 137 according to the interaction between a magnetic field generated by the permanent magnets and a magnetic field generated by three-phase coil 139.

Reduction device RD performs speed reduction through a structure in which a planetary carrier 166 which is one of the rotating elements of the planetary gear is fixed to a case. In other words, reduction gear RD includes a sun gear 162 coupled to an output shaft 160 of rotor 137, a ring gear 168 rotating integrally with ring gear 152, and a pinion gear 164 intermeshing with ring gear 168 and sun gear 162 for transmitting the rotation of sun gear 162 to ring gear 168. For example, if the number of teeth of ring gear 168 is set twice or more relative to the number of teeth of sun gear 162, the reduction ratio can be doubled or more.

Thereby, the rotational force from motor generator MG2 is transmitted through the intermediary of reduction device RD to output member (ring gear case) 155 rotating integrally with ring gears 152 and 168. In other words, motor generator MG2 is configured to apply power from output member 155 to the drive wheels. It should be noted that it is acceptable to couple output shaft 160 of motor generator MG2 to output member 155 without disposing reduction device RD, i.e., without a reduction gear ratio.

Power conversion unit 20 includes a converter 12, and inverters 14 and 22. Converter 12 converts a DC voltage Vb from battery 10 into a DC voltage VH to be applied between a power supply line PL and a ground line GL. In addition, converter 12 is configured to allow bi-directional voltage conversion from DC voltage VH between power supply line PL and ground line GL into DC voltage Vb for charging battery 10 or vice versa.

Inverters 14 and 22 are generally constituted by a three-phase inverter and configured to convert DC voltage VH between power supply line PL and ground line GL into an AC voltage and output the AC voltage to motor generators MG2 and MG1, respectively. Further, inverters 14 and 22 are configured to convert an AC voltage generated respectively by motor generators MG2 and MG1 into DC voltage VH and apply it between power supply line PL and ground line GL.

In hybrid vehicle 5 constructed as described above, ECU 30 stores a table in which accelerator opening degree Acc corresponding to a stepped amount of the accelerator pedal by the driver is associated with a required torque to be output to output member 155. ECU 30, with reference to the table, calculates the required torque to be output to output member 155 on the basis of accelerator opening degree Acc, and controls the operating state of engine ENG and the driving state of motor generators MG1 and MG2 so as to cause a required driving force corresponding to the required torque to be output to output member 155.

(Control Structure)

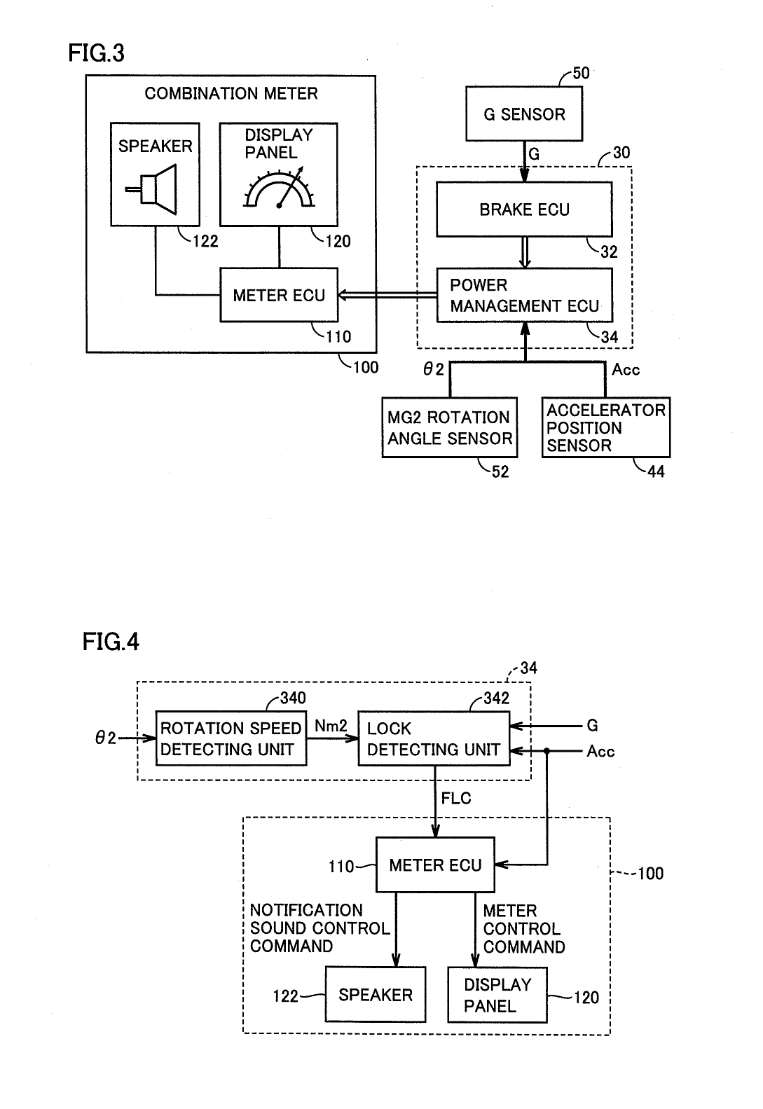

FIG. 3 is a block diagram illustrating a control structure by ECU 30 according to the present embodiment. Each functional block illustrated in FIG. 3 is typically embodied by executing a program stored preliminarily in ECU 30, and it is also acceptable that a part of or the entire part of its functions is implemented by dedicated hardware.

With reference to FIG. 3, ECU 30 includes a brake ECU 32 and a power management ECU 34. Brake ECU 32 and power Management ECU 34 are connected in such a way that they can communicate with each other.

G sensor 50 detects an acceleration of the vehicle and transmits the detection result to brake ECU 32. Brake ECU 32 controls a braking force from a braking device (not shown) on the basis of an output value from G sensor 50.

Rotation angle sensor 52 detects rotor rotation angle θ2 of motor generator MG2 and transmits it to power management ECU 34. Power Management ECU 34, on the basis of the received rotor rotation angle θ2 of motor generator MG2, calculates a rotation speed of motor generator MG2 per unit time (motor rotation speed) Nm2. Power management ECU 34, on the basis of the calculated motor rotation speed Nm2, calculates a speed (vehicular speed) V of hybrid vehicle 5. Vehicular speed V is correspondent to the rotation speed of output member 155. Accelerator position sensor 44 transmits the detected accelerator opening degree Acc to power management ECU 34.

Although not illustrated in the drawings, ECU 30 further includes a battery ECU configured to manage and control a charge and discharge state of battery 10, an engine ECU configured to control an operation state of engine ENG, and a MG_ECU configured to control a driving state of motor generators MG1 and MG2 in accordance with the state of hybrid vehicle 5. Power management ECU 34 controls the entire hybrid system through a reciprocal control and management on battery ECU, engine ECU, MG_ECU, brake ECU 32 and the like so as to make hybrid vehicle 5 run at the best efficiency.

Specifically, power management ECU 34, in accordance with the vehicle state of hybrid vehicle 5 and the driving operations, calculates a vehicle driving force and/or a vehicle braking force required by the whole hybrid vehicle 5. The vehicle state includes vehicular speed V. The driving operations include accelerator opening degree Acc, brake pedal position BP, shift position SP and the like.

To achieve the required vehicle driving force or vehicle braking force, power management ECU 34 determines an output request to motor generators MG1 and MG2 and an output request to engine ENG. Hybrid vehicle 5 may run on only an output from motor generator MG2 while engine ENG is stopped. Thus, it is possible to increase energy efficiency by determining each output request so as to prevent engine ENG from being activated in a region where fuel consumption is poor. The output request to motor generators MG1 and MG2 is set under such a restriction that an electric power range capable of charging or discharging battery 10 is reserved so as to allow battery 10 to be charged or discharged. In other words, in the case where the output power of battery 10 cannot be secured, the output from the motor generator MG2 is restricted.

Power management ECU 34, in accordance with an output request set for motor generators MG1 and MG2, calculates the torque and the rotation speed of motor generators MG1 and MG2, and outputs to MG_ECU a control command about the torque and the rotation speed and a control command value about voltage VH.

Further, power management ECU 34 generates an engine control instruction representing a determined engine power and a desired engine rotation speed and outputs it to engine ECU. In accordance with the engine control instruction, fuel injection, ignition timing, valve timing and the like of engine ENG (not shown) are controlled.

MG_ECU, in accordance with a control command from power management ECU 34, generates a control signal for performing a drive instruction which instructs the conversion of a DC voltage output from converter 12 to an AC voltage for driving motor generator MG1, and a control signal for performing a regeneration instruction which instructs the conversion of an AC voltage generated by motor generator MG1 into a DC voltage to be output back to converter 12. These control commands (MG1 control commands) for motor generator MG1 are output to inverter 22. Similarly, MG_ECU generates a control signal for performing a drive instruction which instructs the conversion of a DC voltage to an AC voltage for driving motor generator MG2, and a control signal for performing a regeneration instruction which instructs the conversion of an AC voltage generated at motor generator MG2 into a DC voltage to be output back to converter 12. These control commands (MG2 control commands) for motor generator MG2 are output to inverter 14.

MG_ECU generates a control signal for performing a voltage step-up instruction, a control signal for performing a voltage step-down instruction, and a shut-down signal for instructing operation inhibitions to converter 12 so as to control DC voltage VH in accordance with the control command from power management ECU 34. Thereby, the charge and discharge power of battery 10 is controlled according to the voltage conversion by converter 12 in response to these control signals.

Power management ECU 34 further controls and manages a meter ECU 110 configured to control a display panel 120 and a speaker 122 which are disposed in combination meter 100.

Here, it is assumed that hybrid vehicle 5 constructed as described above is in a state in which a wheel is in contact with an obstacle such as a step or a wheel block (locked state). In this situation, the rotation speed of output member 155, i.e., the rotation speed of motor generator MG2 is in a very low speed range. It should be noted that as a wheel is in the locked state, since the rotor position of motor generator MG2 is fixed, a current flows continuously into a specific phase of motor generator MG2, and thereby, an inverter element for applying the current to the coil of the specific phase will generate more heat than the other inverter element.

As the accelerator pedal is further stepped down by the driver from the locked state of the wheel, ECU 30 (power management ECU 34) controls the operating state of engine ENG and the driving state of motor generators MG1 and MG2 so as to output the required driving force calculated according to accelerator opening degree Acc corresponding to the stepped amount of the accelerator pedal operated by the driver to output member 155. Consequently, as the driver further steps down the accelerator pedal, the required driving force corresponding to the stepped amount increases. Therefore, when the wheel climbs over an obstacle such as a step or a wheel block to escape from the locked state, it is possible that the driver may have such a feeling that the vehicle is rushing out.

In a normal vehicle with only an engine served as a power source, as the driver steps down the accelerator pedal, the engine speed increases in accordance with the increment of the stepped amount, and accordingly, a driving sound of the engine increases in accordance with the increment of the engine speed. Therefore, when a wheel is in the locked state, through the driving sound of the engine which increases in accordance with the increasing stepped amount of the accelerator pedal, it is possible to make the driver recognize the situation and the operation amount of the accelerator pedal. As a result, it is possible to prevent the driver from further stepping down the accelerator pedal excessively.

In contrast, in an electrically powered vehicle with an electric motor served as a power source, since the driving sound of the electric motor is relatively smaller than the driving sound of the engine, it is difficult to make the driver recognize the situation where a wheel is in the locked state and the operation amount of the accelerator pedal through the driving sound of the electric motor. Thus, it is possible that the driver may misjudge the state where a wheel is in the locked state as a state where a sufficient torque is not output from the electric motor due to an insufficient stepped amount of the accelerator pedal, which thereby makes the driver further step down the accelerator pedal.

Therefore, in the electrically powered vehicle according to the present embodiment, when a wheel is in the locked state, power management ECU 34 controls the notification mode of combination meter 100 so as to notify the driver of information about the accelerator operation.

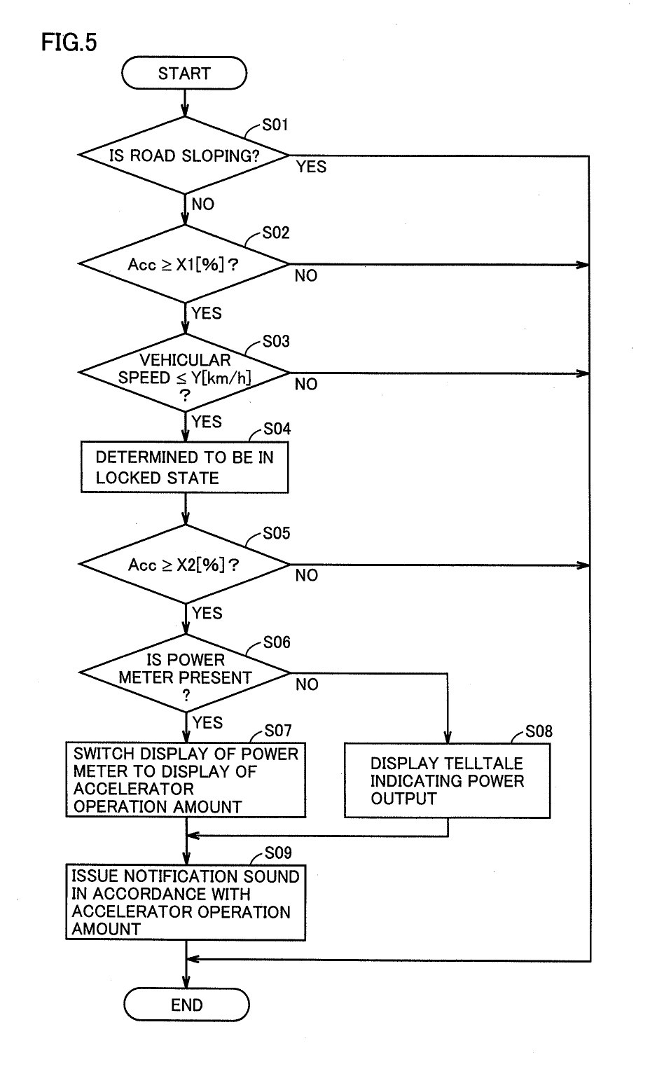

FIG. 4 is a block diagram explaining controls of combination meter 100 according to an embodiment of the present invention.

With reference to FIG. 4, power management ECU 34 includes a MG2 rotation speed detecting unit 340 and a lock detecting unit 342. MG2 rotation speed detecting unit 340 detects MG2 rotation speed Nm2 on the basis of rotor rotation angle θ2 which is detected by rotation angle sensor 52 of motor generator MG2.

Lock detecting unit 342 calculates vehicular speed V (corresponding to the rotation speed of output member 155) on the basis of motor rotation speed Nm2 detected by MG2 rotation speed detecting unit 340. Lock detecting unit 342, on the basis of the calculated vehicular speed V, an output value G from G sensor 50 and an output value Acc from accelerator position sensor 44, detects whether or not a wheel is in the locked state. If the wheel is detected to be in the locked state, lock detecting unit 342 turns on a lock determination flag FLC.

When lock determination flag FLC is turned on, meter ECU 110 issues a meter control command to display panel 120 and a sound control command to speaker 122 so as to notify the driver of the information about the accelerator operation in a mode in which as the accelerator opening degree Acc becomes greater, the driver is made to sense the accelerator operation amount more easily.

FIG. 5 is a flowchart for achieving the controls of combination meter 100 according to an embodiment of the present invention.

With reference to FIG. 5, power management ECU 34, on the basis of the output value from G sensor 50, accelerator opening degree Acc and vehicular speed V, determines whether or not a wheel is in the locked state. Specifically, at step S01, power management ECU 34 firstly determines whether or not a road on which hybrid vehicle 5 is running or parking is sloping on the basis of the output value from G sensor 50.

At step S01, power management ECU 34 estimates a gradient of the road on which hybrid vehicle 5 is running or parking on the basis of the output value of the G sensor 50. Then, on the basis of the estimated gradient of the road, power management ECU 34 determines whether or not the road is sloping. For example, if the estimated gradient of the road is smaller than a prescribed gradient, power management ECU 34 determines that the road on which hybrid vehicle 5 is running or parking is not sloping, i.e., the road is a flat road.

On the other hand, if the estimated gradient of the road is equal to or greater than the prescribed gradient (YES at step S01), power management ECU 34 determines that the road is an ascending road. In the case where the road on which hybrid vehicle 5 is running or parking is an ascending road, the control of combination meter 100 to be described later is not performed. This is because that when the vehicle is running on an ascending road, there is no possibility of giving the driver a feeling that the vehicle is rushing out.

If it is determined that the road on which hybrid vehicle 5 is running or parking is not sloping (NO at step S01), at step S02, power management ECU 34 determines whether or not accelerator opening degree Acc is equal to or greater than a prescribed determination value X1. Determination value X1 is a threshold for determining whether or not the driver is stepping down the accelerator pedal (i.e., X1>0[%]). If accelerator opening degree Acc is smaller than determination value X1 (NO at step S02), power management ECU 34 keeps lock determination flag FLC at OFF and ends the process.

On the other hand, when accelerator opening degree Acc is equal to or greater than determination value X1 (YES at step S02), at step S03, power management ECU 34 determines whether or not vehicular speed V is in a very low vehicular speed range containing a vehicular speed of 0 (V≦Y [km/h]). If vehicular speed V is not in the very low vehicular speed range (NO at step S03), power management ECU 34 keeps lock determination flag FLC at OFF and ends the process.

On the contrary, if vehicular speed V is in the very low vehicular speed range (YES at step S03), at step S04, power management ECU 34 determines that a wheel of hybrid vehicle 5 is in the locked state. Then, power management ECU 34 sets lock determination flag FLC to ON. In other words, the processing of steps S01 to S04 corresponds to the function of lock detecting unit 342 in FIG. 5.

After lock determination flag FLC is set to ON by power management ECU 34, at steps S05 to S09, meter ECU 110 controls the notification mode of display panel 120 and speaker 122 to notify the driver of information about the accelerator operation.

Specifically, at step S05, meter ECU 110 determines whether or not accelerator opening degree Acc is equal to or greater than a prescribed reference amount X2. If accelerator opening degree Acc is smaller than prescribed reference amount X2 (NO at step S05), meter ECU 110 maintains the display mode of combination meter 100 and ends the process. Reference amount X2 is a threshold for determining whether or not the driver is stepping down the accelerator pedal (i.e., X2>0[%]).

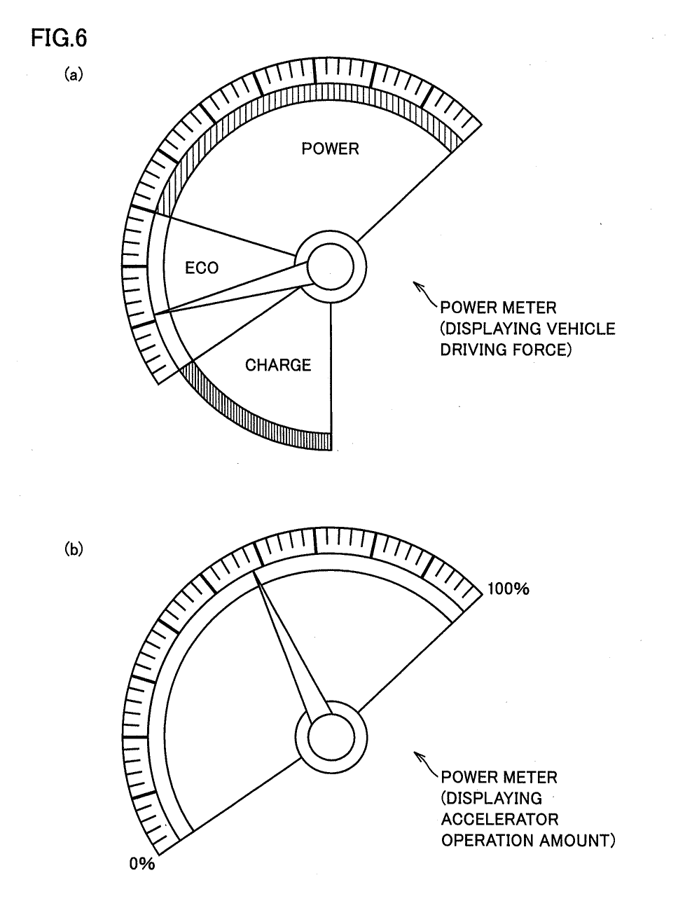

On the other hand, if accelerator opening degree Acc is equal to or greater than prescribed reference amount X2 (YES at step S05), then at step S06, meter ECU 110 determines whether or not a power meter is contained in display panel 120. FIG. 6(a) illustrates an example of the power meter. The power meter is disposed near the driver's seat of hybrid vehicle 5 for displaying a driving force (running power) used to run the vehicle. Power meter is configured as an indicating device for visibly displaying a running power used in the current running by pointing an indicating pointer at a scale mark displayed in a scale plate for indicating running power. The rotation of the indicating pointer is controlled by meter ECU 110. As illustrated in FIG. 6(a), an arc-shaped bar indicating the range of power which can be set as the running power is disposed in the scale plate. Though not illustrated in the drawing, a scale number indicating the corresponding power and a unit symbol indicating the unit [kW] of the power are displayed close to the bar. On the bar, there are displayed with an eco-drive zone (ECO region in the drawing) prioritizing fuel economy at a power less than a upper power limit which is defined on the basis of the relationship between power output from engine ENG and fuel economy or output power available from battery 10 and at which hybrid vehicle 5 can run at perfect fuel economy, a power drive zone (POWER region in the drawing) prioritizing output power rather than fuel economy in a power region equal to or greater than the upper power limit, and a zone (CHARGE region in the drawing) where the running power is negative, in other words, a zone where motor generator MG2 is controlled under a regenerative mode.

Returning to FIG. 5, if a power meter (see FIG. 6(a)) is contained in display panel 120 (YES at step S06), at step S07, meter ECU 110 switches the display mode of the power meter from the display of the vehicle running power to the display of the accelerator pedal operation amount (accelerator opening degree Acc). FIG. 6(b) illustrates an example of a power meter which has been switched to the display of accelerator opening degree Acc.

With reference to FIG. 6(b), an arc-shaped bar indicating a full range of accelerator opening degrees (0-100[%]) which can be set as accelerator opening degree Acc is displayed in the scale plate. Meter ECU 110 controls the power meter to indicate an output value from accelerator position sensor 44 with an indicating pointer. Thus, the power meter serves as an indicating device for visibly displaying current accelerator opening degree Acc. Therefore, it is possible to make the driver sense the operation amount of the accelerator pedal.

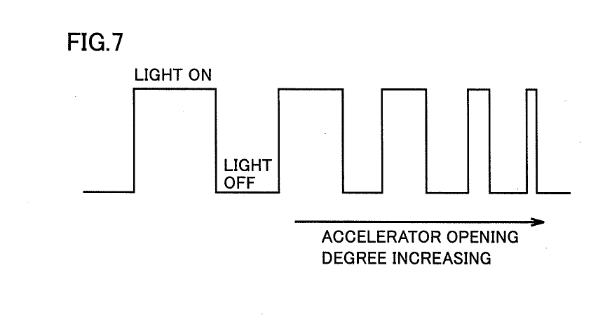

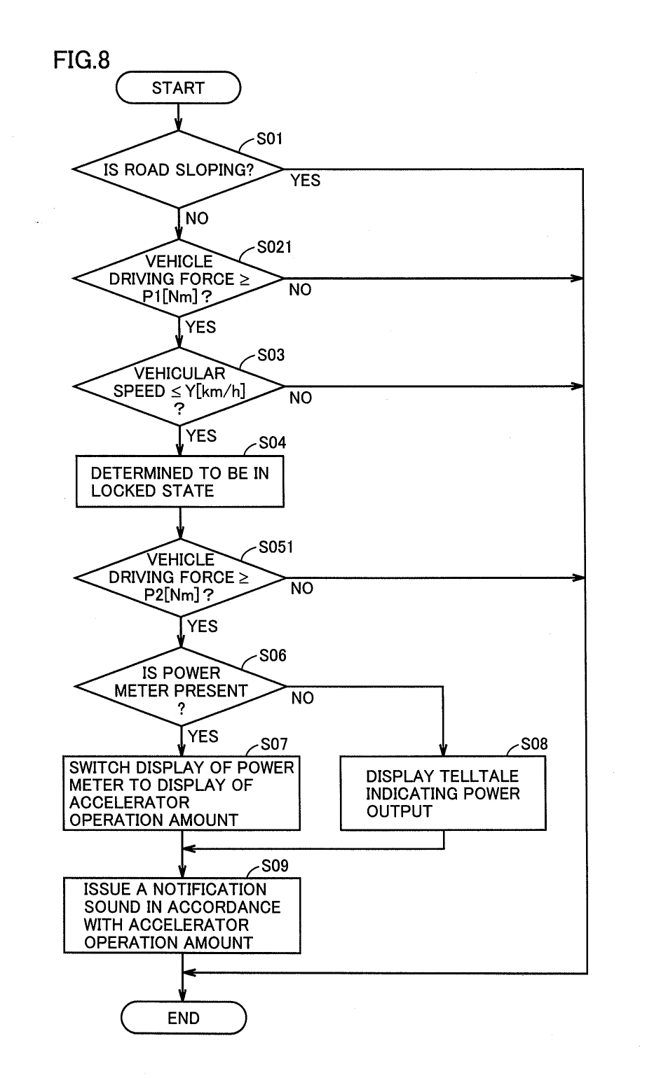

On the other hand, if a power meter is not contained in display panel 120 (NO at step S08), at step S08, meter ECU 110 lights on a telltale which is disposed in display panel 120 for indicating the power output. At this time, if the operation amount of the accelerator pedal is equal to or greater than prescribed reference amount X2, meter ECU 110 alters the display mode of the telltale in accordance with the operation amount of the accelerator pedal. For example, as illustrated in FIG. 7, meter ECU 110 makes a blinking cycle of the telltale shorter on the basis of the output value from accelerator position sensor 44 as the operation amount of the accelerator pedal becomes greater. Accordingly, when the driver further steps down the accelerator pedal, the blinking cycle of the telltale will become shorter, and thereby it is possible to make the driver sense the operation amount of the accelerator pedal.

Instead of being configured to alter the blinking cycle of the telltale in accordance with the operation amount of the accelerator pedal, meter ECU 110 may be configured to alter the displaying brightness or displaying color of the telltale in accordance with the operation amount of the accelerator pedal.

In addition to the control of display panel 120 as described above, at step S09, meter ECU 110 further controls speaker 122 to issue a notification sound about the accelerator operation by the driver when the driver operation amount of the accelerator pedal is equal to or greater than prescribed reference amount X2 (YES at step S05). Specifically, meter ECU 110 alters the issue mode of the notification sound in accordance with the operation amount of the accelerator pedal. For example, meter ECU 110 controls speaker 122 to increase the volume of the notification sound as the operation amount of the accelerator pedal becomes greater. Alternatively, it is acceptable that speaker 122 is controlled to alter the tone of the notification sound in accordance with the operation amount of the accelerator pedal.

Thus, according to the electrically powered vehicle of the present embodiment, in the case where a wheel is in the locked state, display panel 120 (the power meter or the telltale) and speaker 122 are made to notify the driver of the information about the accelerator operation in a mode which makes the driver sense the accelerator operation amount more easily than in the case the wheel is not in the locked state. Thus, it is possible to make the driver recognize that a wheel is in the locked state and the operation amount of the accelerator pedal. As a result, it is possible to prevent the driver from stepping down the accelerator pedal excessively.

### Modification

In the above embodiment, display panel 120 and speaker 122 are configured to be controlled in accordance with accelerator opening degree Acc; however, instead of accelerator opening degree Acc, it is acceptable that display panel 120 and speaker 122 are configured to be controlled in accordance with a vehicle driving force required for hybrid vehicle 5.

FIG. 8 is a flowchart for achieving the controls of combination meter 100 according to a modification of an embodiment of the present invention. Compared with the flowchart of FIG. 5, the determination process for a locked state according to the present modification is performed with steps S01 to S03 in FIG. 5 being replaced by steps S01, S021 and S03, respectively, in the flowchart of FIG. 8.

Specifically, at step S01, if it is determined that the road on which hybrid vehicle 5 is running or parking is not sloping (NO at step S01) on the basis of the output value from G sensor 50, at step S021, power management ECU 34 determines whether or not the required driving force calculated on the basis of accelerator opening degree Acc is equal to or greater than a prescribed determination value P1 [Nm]. Determination value P1 [Nm] is a threshold value for determining whether or not the driver is stepping down the accelerator pedal (P1>0 [Nm]), and is set to a value greater than a creep torque to move the vehicle at a very low speed even when there is no acceleration request from the driver.

When the vehicle driving force is smaller than determination value P1 [Nm] (NO at step S021), power management ECU 34 keeps lock determination flag FLC at OFF and ends the process.

On the other hand, when the vehicle driving force is equal to or greater than determination value P1 (YES at step S021), at step S03, power management ECU 34 determines whether or not vehicular speed V is in a very low vehicular speed range containing the vehicular speed of 0 (V≦Y [km/h]). If vehicular speed V is not in the very low vehicular speed range (NO at step S03), power management ECU 34 keeps lock determination flag FLC at OFF and ends the process.

On the contrary, if vehicular speed V is in the very low vehicular speed range (YES at step S03), at step S04, power management ECU 34 determines that a wheel of hybrid vehicle 5 is in the locked state. Then, power management ECU 34 sets lock determination flag FLC to ON. In other words, the processing of steps S01 to S04 corresponds to the function of lock detecting unit 342 in FIG. 5.

If it is determined that the wheel is in the locked state, at steps S051 to S09, meter ECU 110 controls the notification mode of display panel 120 and speaker 122 so as to notify the driver of the information about the accelerator operation.

Specifically, at step S051, meter ECU 110 determines whether or not the vehicle driving force is equal to or greater than a prescribed reference amount P2. If the vehicle driving force is smaller than prescribed reference amount P2 (NO at step S051), meter ECU 110 maintains the display mode of combination meter 100 and ends the process. Reference amount P2 is a threshold for determining whether or not the driver is stepping down the accelerator pedal and is set to a value greater than the creep torque (i.e., P2>0 [Nm]).

On the other hand, if the vehicle driving force is equal to or greater than prescribed reference amount P2 (YES at step S051), then at step S06, meter ECU 110 determines whether or not a power meter is contained in display panel 120. if a power meter (see FIG. 6(a)) is contained in display panel 120 (YES at step S06), at step S07, meter ECU 110 switches the display mode of the power meter from the display of the vehicle power to the display of the accelerator pedal operation amount (accelerator opening degree Acc) (see FIG. 6(b)).

On the other hand, if a power meter is not contained in display panel 120 (NO at step S06), at step S08, meter ECU 110 lights on a telltale which is disposed in display panel 120. Here, when the vehicle driving force is equal to or greater than prescribed reference amount P2, meter ECU 110 makes the blinking cycle of the telltale shorter as the vehicle driving force becomes greater.

Further at step S09, when the vehicle driving force is equal to or greater than prescribed reference amount P2 (YES at step S051), meter ECU 110 controls speaker 122 to issue a notification sound about the accelerator operation to the driver.

In the present embodiment, the hybrid vehicle having the configuration of FIG. 1 is used as an example of the electrically powered vehicle, and however, the present invention is not limited to be applied to such example. In other words, the present invention may be applied to any hybrid vehicle (for example, the so-called series hybrid vehicle or power-split hybrid vehicle) having a driving system different from FIG. 1, any electric vehicle, and any fuel cell vehicle as long as it is mounted with an electric motor (motor generator) having a driving system which is controlled in accordance with the operation amount of the accelerator pedal.

In the present embodiment, a combination meter including a display panel and a speaker is used as an example of a notification unit capable of notifying the driver of various information; however, the notification unit is not limited to the configuration of such example. In other words, it should be noted that as long as it is possible to alter the notification mode in accordance with the accelerator operation amount in such a manner that makes the driver sense the accelerator operation amount more easily in the case where a wheel is in the locked state than in the case where the wheel is not in the lock state, any configuration can obtain the effects of the present invention.

It should be understood that the embodiments disclosed herein have been presented for the purpose of illustration and description but not limited in all aspects. It is intended that the scope of the present invention is not limited to the description above but defined by the scope of the claims and encompasses all modifications equivalent in meaning and scope to the claims.

### INDUSTRIAL APPLICABILITY

The present invention is applicable to an electrically powered vehicle mounted with an electric motor generating a driving force in accordance with an accelerator operation amount.

### REFERENCE SIGNS LIST

10: battery; 12: converter; 14, 22: inverter; 20: power conversion unit; 40: steering wheel; 44: accelerator position sensor; 46: brake pedal position sensor; 48: shift position sensor; 50: G sensor; 51, 52: rotation angle sensor; 70L, 70R: front wheel; 80L, 80R: rear wheel; 100: combination meter; 120: display panel; 122: speaker; 131, 136: stator; 132,137: rotor; 133, 138: stator core; 134, 139: three-phase coil; 150: crank shaft; 151, 162: sun gear; 152, 168: ring gear; 153, 164: pinion gear; 154, 166: planetary carrier; 155: ring gear case; 160: output shaft; 170: counter drive gear; 340: rotation speed detecting unit; 342: lock detecting unit; DEF: differential gear; 110: meter ECU; 32: brake ECU; 34: power management ECU; ENG: engine; MG1, MG2: motor generator; PSD: power split device; RD: reduction device; RG: power transmission reduction gear

1. An electrically powered vehicle comprising:
an electric motor for generating a vehicle driving force in accordance with an accelerator operation amount by a driver; and
a notification unit for notifying said driver of the accelerator operation amount by said driver in a mode which makes said driver sense the accelerator operation amount more easily in the case where a wheel is in contact with an obstacle than in the case where said wheel is not in contact with the obstacle.

2. The electrically powered vehicle according to claim 1, wherein said notification unit, in the case where said wheel is in contact with the obstacle, notifies said driver of the accelerator operation amount by said driver when said accelerator operation amount is equal to or greater than a prescribed reference amount.

3. The electrically powered vehicle according to claim 1, further comprising an estimation unit for estimating a gradient of a road, wherein
said notification unit determines that said wheel is in contact with the obstacle when a first condition that said estimated gradient of the road is smaller than a prescribed threshold, a second condition that said accelerator operation amount is equal to or greater than a prescribed amount, and a third condition that a vehicular speed is smaller than a prescribed speed are satisfied.

4. The electrically powered vehicle according to claim 2, wherein
said notification unit includes a display unit for displaying at least a parameter about a vehicle driving force generated by said electric motor, and
said display unit displays said accelerator operation amount when said accelerator operation amount is equal to or greater than said prescribed reference amount.

5. The electrically powered vehicle according to claim 2, wherein
said notification unit includes a light source configured to be capable of blinking, and
said light source alters a blinking cycle in accordance with said accelerator operation amount when said accelerator operation amount is equal to or greater than said prescribed reference amount.

6. The electrically powered vehicle according to claim 1, wherein said notification unit includes a sound output unit configured to be capable of generating a sound.

7. A control method for an electrical vehicle including an electric motor capable of generating a vehicle driving force in accordance with an accelerator operation amount by a driver and a notification unit for notifying said driver of information, comprising the steps of:
detecting a state in which a wheel is in contact with an obstacle;
detecting the accelerator operation amount by said driver; and
controlling said notification unit to notify said driver of the accelerator operation amount by said driver in a mode which makes said driver sense the accelerator operation amount more easily in the case where the state in which said wheel is in contact with the obstacle is detected than in the case where said wheel is not in contact with the obstacle.

8. The electrically powered vehicle according to claim 2, wherein said notification unit includes a sound output unit configured to be capable of generating a sound.
